(19) United States
(12) Patent Application Publication
(10) Pub. No.: US 2022/0214179 A1
(43) Pub. Date: Jul. 7, 2022

(54) Hierarchical Coarse-Coded Spatiotemporal Embedding For Value Function Evaluation In Online Order Dispatching

(71) Applicant: BEIJING DIDI INFINITY TECHNOLOGY AND DEVELOPMENT CO., LTD., Beijing (CN)

(72) Inventors: Xiaocheng Tang, Mountain View, CA (US); Zhiwei Qin, Mountain View, CA (US); Fan Zhang, Mountain View, CA (US); Jieping Ye, Mountain View, CA (US)

(21) Appl. No.: 17/618,861

(22) PCT Filed: Jun. 14, 2019
(86) PCT No.: PCT/CN2019/091225

§ 371 Date: Dec. 13, 2021

(51) Int. Cl. G01C 21/34; B60W 40/09

(52) U.S. Cl. CPC G01C 21/3438; B60W 40/09; G01C 21/3484

(57) ABSTRACT

A system for evaluating order dispatching policy includes a first computing device, at least one processor, and a memory. The first computing device is configured to generate historical driver data associated with a driver. The at least one processor is configured to store instructions. When executed by the at least one processor, the instructions cause the at least one processor to perform operations. The operations performed by the at least one processor includes obtaining the generated historical driver data associated with the driver. Based at least in part on the obtained historical driver data, a value function is estimated. The value function is associated with a plurality of order dispatching policies. An optimal order dispatching policy is then determined. The optimal order dispatching policy is associated with an estimated maximum value of the value function. The estimation of the value function applies a cerebellar model arithmetic controller.

### FIELD

This disclosure generally relates to methods and devices for order dispatching, and in particular, to methods and devices for hierarchical coarse-coded spatiotemporal embedding for dispatching policy evaluation.

### BACKGROUND

A ride-share platform capable of driver-passenger dispatching often makes decisions for assigning available drivers to nearby unassigned passengers over a large spatial decision-making region. Therefore, it is critical to diligently capture the real-time transportation supply and demand dynamics.

### SUMMARY

Various embodiments of the present disclosure can include systems, methods, and non-transitory computer readable media for optimization of order dispatching.

According to some implementations of the present disclosure, a system for evaluating order dispatching policy includes a computing device, at least one processor, and a memory. The computing device is configured to generate historical driver data associated with a driver. The at least one processor is configured to store instructions. When executed by the at least one processor, the instructions cause the at least one processor to perform operations. The operations performed by the at least one processor includes obtaining the generated historical driver data associated with the driver. Based at least in part on the obtained historical driver data, a value function is estimated. The value function is associated with a plurality of order dispatching policies. An optimal order dispatching policy is then determined. The optimal order dispatching policy is associated with an estimated maximum value of the value function.

According to some implementations of the present disclosure, a method for evaluating order dispatching policy includes generating historical driver data associated with a driver. Based at least in part on the obtained historical driver data, a value function is estimated. The value function is associated with a plurality of order dispatching policies. An optimal order dispatching policy is then determined. The optimal order dispatching policy is associated with an estimated maximum value of the value function.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Embodiments are illustrated by way of example and not limitation in the figures of the accompanying drawings, in which like references indicate similar elements and in which:

FIG. 1 illustrates a block diagram of a transportation hailing platform according to an embodiment;

FIG. 2 illustrates a block diagram of an exemplary dispatch system according to an embodiment;

FIG. 3 illustrates a block diagram of another configuration of the dispatch system of FIG. 2;

FIG. 4 illustrates a block diagram of the dispatch system of FIG. 2 with function approximators;

FIG. 5 illustrates a decision map of a user of the transportation hailing platform of FIG. 1 according to an embodiment;

FIG. 6 illustrates a block diagram of the dispatch system of FIG. 4 with training;

FIG. 7 illustrates a hierarchical hexagon grid system according to an embodiment; and

FIG. 8 illustrates a flow diagram of a method to evaluate order dispatching policy according to an embodiment.

### DETAILED DESCRIPTION

A ride-share platform capable of driver-passenger dispatching makes decisions for assigning available drivers to nearby unassigned passengers over a large spatial decision-making region (e.g., a city). An optimal decision-making policy requires the platform to take into account both the spatial extent and the temporal dynamics of the dispatching process because such decisions can have long-term effects on the distribution of available drivers across the spatial decision-making region. The distribution of available drivers critically affects how well future orders can be served.

However, the existing technologies often assume a single driver perspective or restrict the model space to only tabular cases. To overcome the inadequacy of current technologies and to provide a better order dispatching for ride-share platforms, some implementations of the present disclosure build upon the existing learning and planning approach and improve it with temporal abstraction and function approximation. As a result, the present disclosure captures the real-time transportation supply and demand dynamics.

Furthermore, the present disclose enables learning and planning at different geographical resolution levels. For example, some embodiments of the present disclosure utilize a sparse coarse-coded function approximator. Other benefits of the present disclosure include the ability to stabilize the training process by reducing the accumulated approximation errors. Finally, the present disclosure allows for the training process to be performed offline, thereby achieving a state-of-the-art dispatching efficiency. In sum, the disclosed systems and methods can be scaled to real-world ride-share platforms that serve millions of order requests in a day.

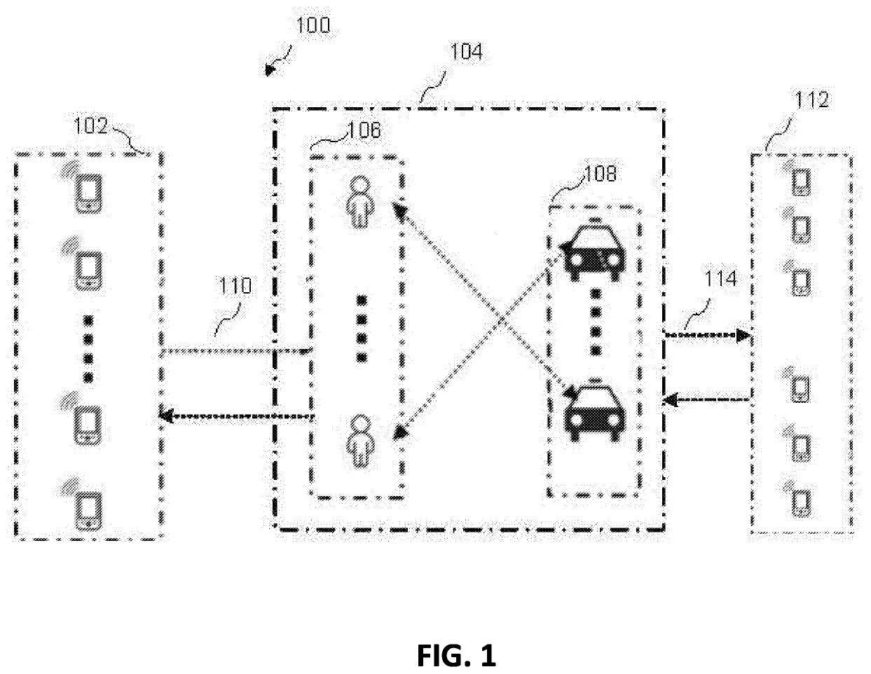

FIG. 1 illustrates a block diagram of a transportation hailing platform 100 according to an embodiment. The transportation hailing platform 100 includes client devices 102 configured to communicate with a dispatch system 104. The dispatch system 104 is configured to generate an order list 106 and a driver list 108 based on information received from one or more client devices 102 and information received from one or more transportation devices 112. The transportation devices 112 are digital devices that are configured to receive information from the dispatch system 104 and transmit information through a communication network 112. For some embodiments, communication network 110 and communication network 112 are the same network. The one or more transportation devices are configured to transmit location information, acceptance of an order, and other information to the dispatch system 104. For some embodiments, the transmission and receipt of information by the transportation device 112 is automated, for example by using telemetry techniques. For other embodiments, at least some of the transmission and receipt of information is initiated by a driver.

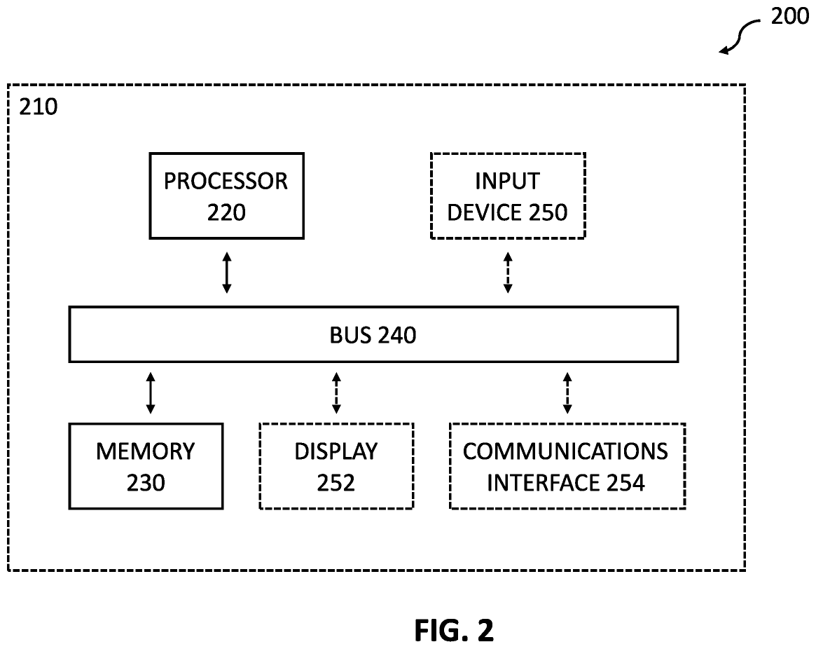

The dispatch system 104 can be configured to optimize order dispatching by policy evaluation with function approximation. For some implementations, the dispatch system 104 includes one or more systems 200 such as that illustrated in FIG. 2. Each system 200 can comprise at least one computing device 210. In one embodiment, the computing device 210 includes at least one central processing unit (CPU) or processor 220, at least one memory 230, which are coupled together by a bus 240 or other numbers and types of links, although the computing device may include other components and elements in other configurations. The computing device 210 can further include at least one input device 250, at least one display 252, or at least one communications interface system 254, or in any combination thereof. The computing device 210 may be or as a part of various devices such as a wearable device, a mobile phone, a tablet, a local server, a remote server, a computer, or the like.

The input device 250 can include a computer keyboard, a computer mouse, a touch screen, and/or other input/output device, although other types and numbers of input devices are also contemplated. The display 252 is used to show data and information to the user, such as the customer's information, route information, and/or the fees collected. The display 252 can include a computer display screen, such as an OLED screen, although other types and numbers of displays could be used. The communications interface system 254 is used to operatively couple and communicate between the processor 220 and other systems, devices and components over a communication network, although other types and numbers of communication networks or systems with other types and numbers of connections and configurations to other types and numbers of systems, devices, and components are also contemplated. By way of example only, the communication network can use TCP/IP over Ethernet and industry-standard protocols, including SOAP, XML, LDAP, and SNMP, although other types and numbers of communication networks, such as a direct connection, a local area network, a wide area network, modems and phone lines, e-mail, and wireless communication technology, each having their own communications protocols, are also contemplated.

The central processing unit (CPU) or processor 220 executes a program of stored instructions for one or more aspects of the technology as described herein. The memory 230 stores these programmed instructions for execution by the processor 220 to perform one or more aspects of the technology as described herein, although some or all of the programmed instructions could be stored and/or executed elsewhere. The memory 230 may be non-transitory and computer-readable. A variety of different types of memory storage devices are contemplated for the memory 230, such as random access memory (RAM), read only memory (ROM) in the computing device 210, floppy disk, hard disk, CD ROM, DVD ROM or other computer readable medium read from and/or written to by a magnetic, optical, or other reading and/or writing controllers/systems coupled to the processor 220, and combinations thereof. By way of example only, the memory 230 may include mass storage that is remotely located from the processor 220.

The memory 230 may store the following elements, or a subset or superset of such elements: an operating system, a network communication module, a client application. An operating system includes procedures for handling various basic system services and for performing hardware dependent tasks. A network communication module (or instructions) can be used for connecting the computing device 210 to other computing devices, clients, peers, systems or devices via one or more communications interface systems 254 and one or more communication networks, such as the Internet, other wide area networks, local area networks, metropolitan area networks, and other type of networks. The client application is configured to receive a user input to communicate with across a network with other computers or devices. For example, the client application may be a mobile phone application, through which the user may input commands and obtain information.

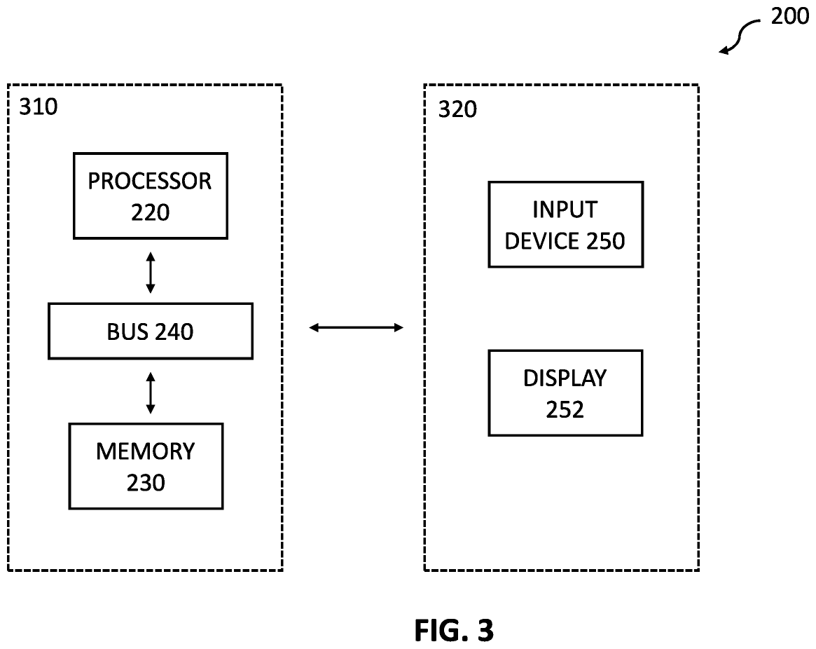

In another embodiment, various components of the computing device 210 described above may be implemented on or as parts of multiple devices, instead of all together within the computing device 210. As one example and shown in FIG. 3, the input device 250 and the display 252 may be implemented on or as a first device 310 such as a mobile phone; and the processor 220 and the memory 230 may be implemented on or as a second device 320 such as a remote server.

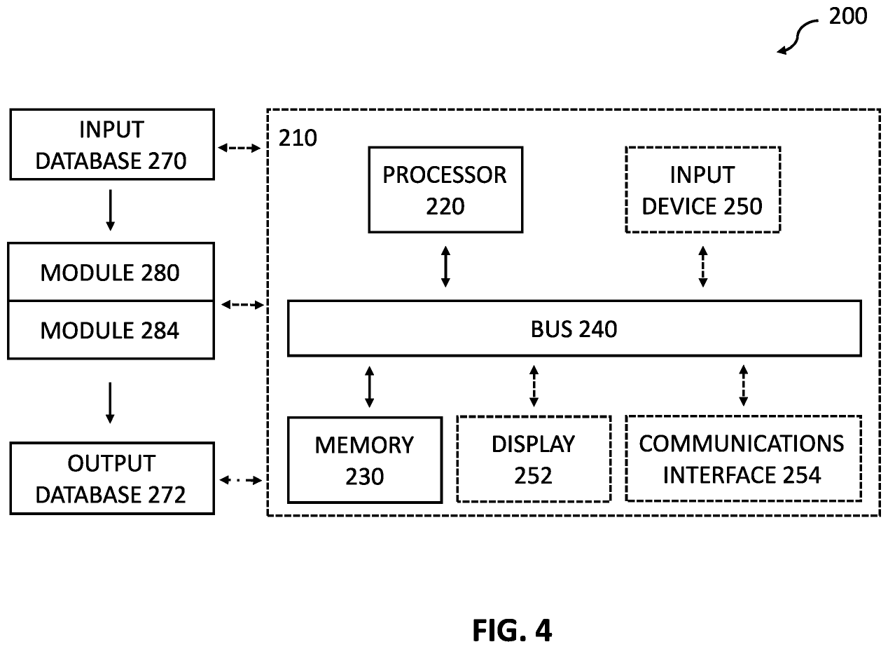

As shown in FIG. 4, the system 200 may further include an input database 270, an output database 272, and at least one approximation module. The databases and approximation modules are accessible by the computing device 210. In some implementations (not shown), at least a part of the databases and/or at least a part of the plurality of approximation modules may be integrated with the computing device as a single device or system. In some other implementations, the databases and the approximation modules may operate as one or more separate devices from the computing device. The input database 270 stores input data. The input data may be derived from different possible values from inputs such as spatiotemporal statuses, physical locations and dimensions, raw time stamps, driving speed, acceleration, environmental characteristics, etc.

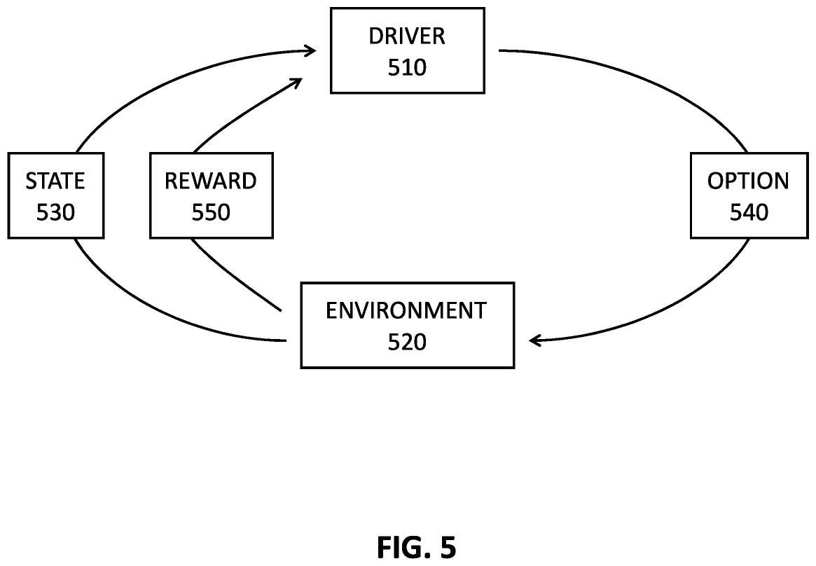

According to some implementations of the present disclosure, order dispatching policies can be optimized by modeling the dispatching process as a Markov decision process (“MPD”) that is endowed with a set of temporally extended actions. Such actions are also known as options and the corresponding decision process is known as a semi-Markov decision process, or SMDP. In an exemplary embodiment, a driver interacts episodically with an environment at some discrete time step t. The time step t is an element of a set of time steps [symbol] , until a terminal time step T is reached. For example, t∈ [symbol] :={0, 1, 2, . . . , T}. As shown in FIG. 5, the input data associated with a driver 510 can include a state 530 of the environment 520 perceived by the driver 510, an option 540 of available actions to the driver 510, and a reward 550 resulted from the driver's choosing a particular option at a particular state.

At each time step t, the driver perceives a state of the environment, described by a feature vector sₜ. The state sₜ at time step t is a member of a set of states S, where S describes all the past states up until that current state sₜ. Based at least in part on the perceived state of the environment sₜ, the driver chooses an option oₜ, where the option oₜ is a member of a set of options [symbol] ₛ_{ₜ}. The option oₜ terminates when the environment is transitioned into another state s_{t′} at time step t′ (e.g., t′=t+kₒ_{ₜ}). As a response, the driver receives a finite numerical reward (e.g., a profit or loss) r_{w} for each t<w≤t+kₒ_{ₜ} before the option oₜ terminates. Therefore, the expected rewards rₛₜ^{o} of the options oₜ is defined as

$${r}_{st}^{o} : = E \{ {r}_{t + 1} + γ {r}_{t + 2} + … + {γ}^{{k}_{{o}_{t}} - 1} {r}_{t + {k}_{{o}_{t}}} \vert {s}_{t} = s , {o}_{t} = o \} ,$$

where γ is the discount factor as described in more detail below. As shown in FIG. 4, and in the context of order dispatching, the above variables can be described as follows:

State 530, denoted by sₜ, is representative of a spatiotemporal status lₜ of the driver 510, a raw time stamp μₜ, as well as a contextual feature vector given by v(lₜ), such that sₜ:=(lₜ,μₜ, v(lₜ)). The raw time stamp μₜ reflects the time scale in the real world and is independent of the discrete time t that is described above. The contextual query function v(⋅) obtains the contextual feature vector v(lₜ) at the spatiotemporal status of the driver it. One example of the contextual feature vector v(lₜ) is real-time characteristics of supplies and demands within the vicinity of lₜ. In addition, the contextual feature vector v(lₜ) may also contain static properties such as driver service statics, holiday indicators, or the like, or in any combination thereof.

Option 540, denoted by oₜ, is representative of a transition of the driver 510 from a first spatiotemporal lₜ status to second spatiotemporal status lₜ, in the future, such that oₜ:=lₜ, where t′>t. The transition can happen due to, for example, a trip assignment or an idle movement. In the case of a trip assignment, the option oₜ is the trip assignment's destination and estimated arriving time, and the option oₜ results in a nonzero reward rₒ_{ₜ}. In contrast, an idle movement leads to a zero-reward transition that only terminates when the next trip option is activated.

Reward 550, denoted by rₒ_{ₜ}, is representative of a total fee collected from a trip Γₜ with the driver 510 who transitioned from sₜ to sₜ, by executing option oₜ. The reward rₒ_{ₜ} is zero if the trip Γₜ is generated from an idle movement. However, if the trip Γₜ is generated from fulfilling an order (e.g., a trip assignment), the reward rₒ_{ₜ} is calculated over the duration of the option oₜ, such that

$${r}_{{o}_{t}} = {r}_{t + 1} + γ {r}_{t + 2} + … + {γ}^{{k}_{{o}_{t}} - 1} {r}_{t + {k}_{{o}_{t}}}$$

where t′=t+kₒ_{ₜ}. The constant γ may include a discount factor for calculating a net present value of future rewards based on a given interest rate, where 0≤γ≤1.

In some embodiments, the at least one approximation module of the system 200 includes an input module 280 coupled to the input database 270, as best shown in FIG. 4. The input module 280 is configured to execute a policy in a given environment, based at least in part on a portion of the input data from the input database 270, thereby generating a history of driver trajectories as outputs. Policy, denoted by π(o|s), describes the way of acting associated with the driver. The policy is representative of a probability of taking an option o in a state s regardless of a time step t. Executing the policy π in a given environment generates a history of driver trajectories denoted as {τᵢ} [symbol] , where [symbol] is a set of indices referring to the driver trajectories. The history of driver trajectories can include a collection of previous states, options, and rewards associated with the driver. The history of driver trajectories {τᵢ} [symbol] can therefore be expressed such that {τᵢ} [symbol] :={(sᵢ₀, oᵢ₀, rᵢ₁, sᵢ₁, oᵢ₁, rᵢ₂, . . . , r_{iT}_{ᵢ}, s_{iT}_{ᵢ})} [symbol] .

The at least one approximation module may also include a policy evaluation module 284 coupled to the input module 280 and the output database 272. The policy evaluation module 284 can be derived from value functions as described below. The results of the input module 280 are used by the policy evaluation module 284 to learn the policies for evaluation that will have a high probability of obtaining the maximum long-term expected cumulative reward, by solving or estimating the value functions. The outputs of the policy evaluation module 284 are stored in the output database 272. The resulting data provides optimal policies for maximizing the long-term cumulative reward of the input data.

As such, to aid in the learning of the optimal policies, the policy evaluation module 284 is configured to use value functions. There are two types of value functions that are contemplated: a state value function and an option value function. The state value function describes the value of a state when following a policy. In one embodiment, the state value function is the expected cumulative reward when a driver starting from a state acting according to a policy. In other words, the state-value function is representative of an expected cumulative reward V^{π}(s) that the driver will gain starting from a state s and following a policy π until the end of an episode. The cumulative reward V^{π}(s) can be expressed as a sum of total rewards accrued over time of the state s under the policy π, such that

$${V}^{π} ( s ) : = E \{ {Σ}_{i = t + 1}^{T} {γ}^{i - t - 1} {r}_{i} \vert {s}_{t} = s \} .$$

It is important to note that even for the same environment, the value function changes depending on the policy. This is because the value of the state changes depending on how a driver acts, since the way the driver acts in a particular state affects how much reward he/she will receive. Also note the importance of the word “expected”. The reason the cumulative reward is an “expected” cumulative reward is that there is some randomness in what happens after a driver arrives at a state. When the driver selects an option at a first state, the environment returns a second state. There may be multiple states it could return, even given only one option. In some situations, the policy may be stochastic. As such, the state value function can estimate the cumulative reward as an “expectation.” To maximize the cumulative reward, the policy evaluation is therefore also estimated.

The option value function is the value of taking an option in some state when following a certain policy. It is the expected return given the state and action under the certain policy. Therefore, the option-value function is representative of an value Q^{π}(s, o) of the driver's taking an option o in a state s and following the policy π until the end. The value Q^{π}(s, o) can be expressed as a sum of total rewards accrued over time of the option o in the state s under the policy π, such that

$${Q}^{π} ( s , o ) := E \{ {\sum }_{i = t + 1}^{T} {γ}^{i - t - 1} {r}_{i} \vert {s}_{t} = s , {o}_{t} = o \} .$$

Similar to the “expected” cumulative reward in the state value function, the value of the option value function is also “expected.” The “expectation” takes into account the randomness in future option according to the policy, as well as the randomness of the returned state from the environment.

Given the above value functions and the driver history trajectories [symbol] , the value of the underlying policy π can be estimated. Similar to a standard MDP, general policies and options can be expressed as Bellman equations. The policy evaluation module 284 is configured to utilize the Bellman equations as approximators because the Bellman equations allow the approximation of one variable to be expressed as other variables. The Bellman equation for the expected cumulative reward V^{π}(s) is therefore:

$$\begin{matrix}{V}^{π} ( s ) = E \{ {r}_{t + 1} + … + {γ}^{{k}_{{o}_{t}} - 1} {r}_{t + {k}_{{o}_{t}}} + {γ}^{{k}_{{o}_{t}}} {V}^{π} ( {s}_{t + {k}_{{o}_{t}}} ) \vert {s}_{t} = s \} \\ = E \{ {r}_{st}^{o} + {γ}^{{k}_{{o}_{t}}} {V}^{π} ( {s}_{t + {k}_{{o}_{t}}} ) \vert {s}_{t} = s \}\end{matrix} \qquad ( 1 )$$

Where variable kₒ_{ₜ} is a duration of an option oₜ selected by a policy π at a time step t, and reward rₛₜ^{o} is the corresponding accumulative discounted reward received through the course of the option oₜ. Similarly, the Bellman equation for the value Q^{π}(s, o) of an option o in a state s∈S is

$${Q}^{π} ( s , o ) = E \{ {r}_{st}^{o} + {γ}^{{k}_{o}} {Σ}_{{o}^{′} ∈ {𝒪}_{t + {k}_{o}}} π ( {o}^{′} \vert {s}_{t + {k}_{o}} ) {Q}^{π} ( {s}_{t + {k}_{o}} , {o}^{′} ) \vert {s}_{t} = s , {o}_{t} = o \} \qquad ( 2 )$$

where variable kₒ is a determined constant because it is given that oₜ=o in equation (2). In contrast, in equation (1), the variable kₒ_{ₜ} is a random variable that is dependent on the option oₜ which the policy π selects at time step t.

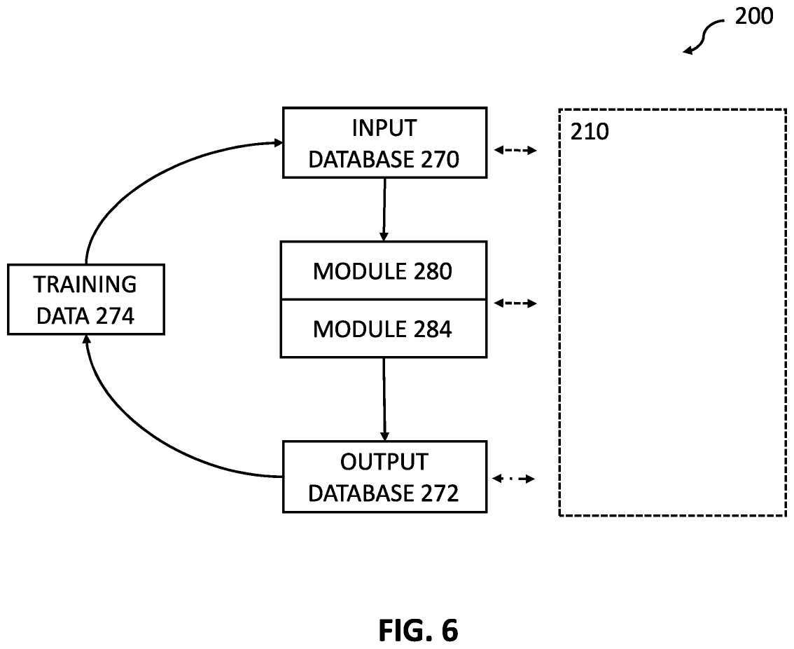

In some embodiments, the system 200 is further configured to use training data 274 in the form of information aggregation and/or machine learning. The inclusion of training data improves the value function estimations/approximations described in the sections above. Recall that the policies are evaluated as an estimation or approximation under the value functions because of the randomness associated with the policies and the states. Therefore, to improve the accuracy of the value function approximations, the system 200 is configured to run a plurality of iteration sessions for information aggregation and/or machine learning, as best shown in FIG. 6. In this embodiment, the system 200 is configured to receive additional input data including training data 274. The training data 274 may provide sequential feedback to the policy evaluation module 284 to further improve the approximators. Additionally or alternatively, real-time feedback may be provided from the previous outputs (e.g., existing outputs stored in the output database 272) of the policy evaluation module 284 upon receipt of real-time input data as updated training data 274 to further evaluate the approximators. Such feedback may be delayed to speed up the processing. As such, the system may also be run on a continuous basis to determine the optimal policies.

When using the Bellman equations to aggregate information under the value function approximations, the training process (e.g., iterations) can become unstable. Partly because of the recursive nature of the aggregation, any small estimation or prediction errors from the function approximator can quickly accumulate and render the approximation useless. To reduce prediction errors and to obtain a better state representation, the training data 274 can be configured to utilize a cerebellar model arithmetic controller (“CMAC”) with embedding. As such, because of the reduced prediction errors, the system 200 has the benefit of stabilizing the training process. A CMAC is a sparse, coarse-coded function approximator which maps a continuous input to a high dimensional sparse vector. An example of embedding is the process of learning a vector representation for each target object.

In one embodiment, the CMAC mapping uses multiple tilings of a state space. The state space is representative of memory space occupied by the variable “state” as described above. For example, the state space can include latitude, longitude, time, other features associated with the driver's current status, or any combination thereof. In one embodiment, the CMAC method can be applied to a geographical location of a driver. The geographical location can be encoded, for example, using a pair of GPS coordinates (latitude, longitude). In such embodiment, a plurality of quantization (or tiling) functions is defined as {q₁, . . . , qₙ}. Each quantization function maps the continuous input of the state to a unique string ID that is representative of a discretized region (or cell) of a state space.

Different quantization function maps the input to different string IDs. Each string ID can be represented by a vector that is learned during training (e.g., via embedding). The memory required to store the embedding matrix is the size of a total number of unique string IDs multiplied by the dimension of the embedding matrix, which often times can be too large. To overcome this deficiency, the system is configured to use a process of “hashing” to reduce the dimension of the embedding matrix. That is, a numbering function A maps each string ID to a number in a fixed set of integers [symbol] . The size of the fixed set of integers [symbol] can be much smaller than the number of unique string IDs. Given all available unique string IDs, the numbering function can therefore be defined by mapping each string ID to a unique integer i starting from 0, 1, . . . . Let A denote such numbering function and cursive [symbol] denotes the index set containing all of the unique integers used to index the discretized regions described above, such that for all unique integers i, A(qᵢ(lₜ))∈ [symbol] . In addition, for all i≠j, qᵢ(lₜ)≠qⱼ(lₜ). Therefore, the output of CMAC c(lₜ) is a sparse | [symbol] |-dimensional vector with exactly n non-zero entries with A(qᵢ(lₜ))-th entry equal to 1 for all unique integers i, such that c_{A}(q(lₜ))=1, ∀i.

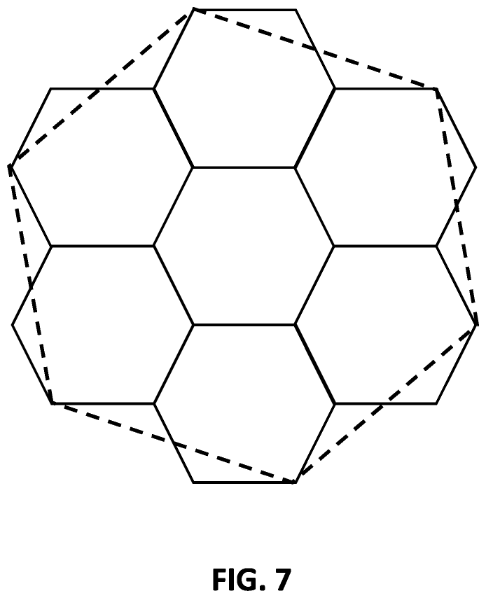

According to some embodiments, a hierarchical polygon grid system is used to quantize the geographical space. For example, a polygon grid system can be used, as illustrated in FIG. 7. Using a substantially equilateral hexagon as the shape for the discretized region (e.g., cell) is beneficial because hexagons have only one distance between a hexagon center point and each of its adjacent hexagons' center points. Further, a hexagon can be tiled in a plane while still closely resemble a circle. Therefore, the hierarchical hexagon grid system of the present disclosure supports multiple resolutions, with each finer resolution having cells with one seventh the area of the coarser resolution. The hierarchical hexagon grid system, capable of hierarchical quantization with different resolutions, enables the information aggregation (and in turn the learning) to happen at different abstraction levels. As a result, the hierarchical hexagon grid system can automatically adapt to the nature of a geographical district (e.g., downtown, suburbs, community parks, etc.).

Further, an embedding matrix θ^{M}, where θ^{M}∈ [symbol] , is representative of each cell in the grid system as a dense m-dimensional vector. The embedding matrix is the implementations of the embedding process, for example, the process of learning a vector representation for each target object. The output of CMAC c(lₜ) is multiplied by the embedding matrix θ^{M}, yielding a final dense representation of the driver's geographical location c(lₜ)^{T}θ^{M}, where the embedding matrix θ^{M} is randomly initialized and updated during training.

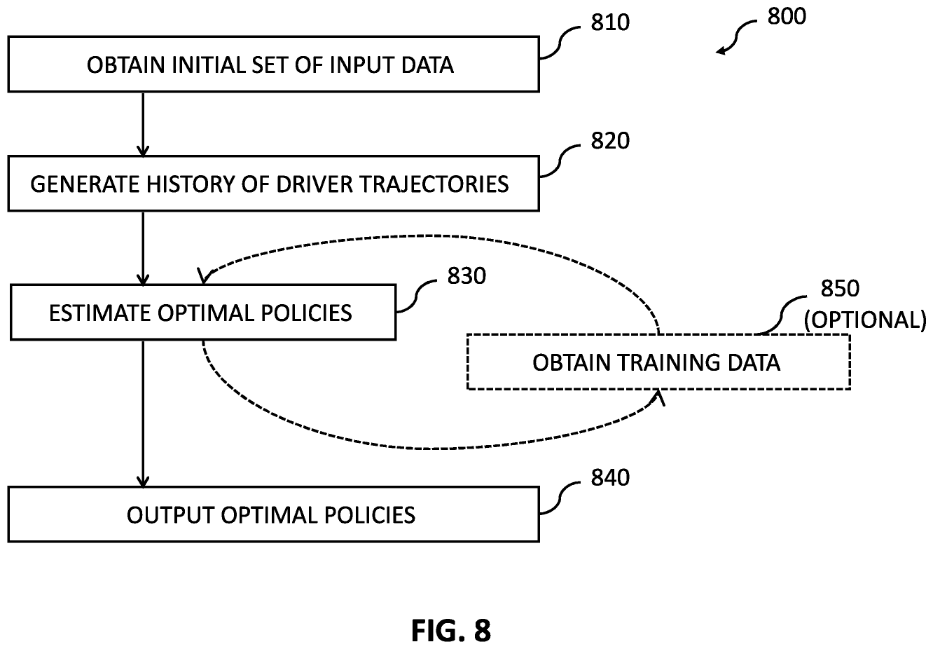

FIG. 8 illustrates a flow diagram of an exemplary method 800 to evaluate order dispatching policy according to an embodiment. In the process, the system 200 obtains an initial set of input data stored in the input database 270 (810). The input module 280 models the initial set of input data according to a semi-Markov decision process. Based at least in part on the obtained initial set of input data, the input module 280 generates a history of driver trajectories as outputs (820). The policy evaluation module 284 receives the outputs of the input module 280 and determines, based at least in part on the received outputs, optimal policies for maximizing long-term cumulative reward associated with the input data (830). The determination of the optimal policies may be an estimation or approximation according to a value function. The outputs of the policy evaluation module 284 are stored in the output database 272 in a memory device (840).

Additionally or alternatively, the system 200 may obtain training data 274 for information aggregation and/or machine learning to improve the accuracy of the value function approximations (850). Based at least in part on the training data 274, the policy evaluation module 284 updates the estimation or approximation of the optimal policies and generates updated outputs (830). The updating process (e.g., obtaining additional training data) can be repeated more than once to further improve the value function approximations. For example, the updating process may include real-time input data as training data, the real-time input data being transmitted from the computing device 210.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The exemplary blocks or states may be performed in serial, in parallel, or in some other manner. Blocks or states may be added to or removed from the disclosed exemplary embodiments. The exemplary systems and components described herein may be configured differently than described. For example, elements may be added to, removed from, or rearranged compared to the disclosed exemplary embodiments.

The various operations of exemplary methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function, but can learn from training data to make a predictions model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some exemplary embodiments, the processors or processor-implemented engines may be located in a single geographic location (e.g., within a home environment, an office environment, or a server farm). In other exemplary embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific exemplary embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, the term “or” may be construed in either an inclusive or exclusive sense. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the exemplary configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A system for evaluating order dispatching policy, the system comprising:
a computing device for generating historical driver data associated with a driver;
at least one processor; and
a memory storing instructions, the instructions when executed by the at least one processor, causes the at least one processor to perform operations, the operations comprising:
obtaining the generated historical driver data associated with the driver,
based at least in part on the obtained historical driver data, estimating a value function associated with a plurality of order dispatching policies, and
determining an optimal order dispatching policy, the optimal order dispatching policy being associated with an estimated maximum value of the value function.

2. The system of claim 1, wherein the generated historical driver data includes a state of the environment associated with the driver, the state of the environment including a spatiotemporal status of the driver and a contextual feature vector, the contextual feature vector being associated with the spatiotemporal status of the driver.

3. The system of claim 2, wherein the contextual feature vector is indicative of a static property of the driver.

4. The system of claim 2, wherein the generated historical driver data further includes an option available to the driver, the option being indicative of a transition of the driver from a first spatiotemporal status to a second spatiotemporal status, the second spatiotemporal status being more advanced in time than the first spatiotemporal status.

5. The system of claim 4, wherein the generated historical driver data further includes a reward, the reward being indicative of a total return over the duration of the transition of the driver from the first spatiotemporal status to the second spatiotemporal status.

6. The system of claim 1, wherein the estimating a value function associated with a plurality of order dispatching policies further comprises iteratively incorporating training data and updating in each iteration the estimation of the value function.

7. The system of claim 6, wherein updating in each iteration the estimation of the value function applies a cerebellar model arithmetic controller.

8. The system of claim 7, wherein the output from the cerebellar model arithmetic controller is a sparse multi-dimensional vector.

9. The system of claim 6, wherein updating in each iteration the estimation of the value function applies a hierarchical polygon grid system.

10. The system of claim 9, wherein the hierarchical polygon grid system is a hexagon grid system.

11. A method for evaluating order dispatching policy, the method comprising:
generating historical driver data associated with a driver;
based at least in part on the generated historical driver data, estimating a value function associated with a plurality of order dispatching policies; and
determining an optimal order dispatching policy, the optimal order dispatching policy being associated with an estimated maximum value of the value function.

12. The system of claim 11, wherein the generated historical driver data includes a state of the environment associated with the driver, the state of the environment including a spatiotemporal status of the driver and a contextual feature vector, the contextual feature vector being associated with the spatiotemporal status of the driver.

13. The system of claim 12, wherein the contextual feature vector is indicative of a static property of the driver.

14. The system of claim 12, wherein the generated historical driver data further includes an option available to the driver, the option being indicative of a transition of the driver from a first spatiotemporal status to a second spatiotemporal status, the second spatiotemporal status being more advanced in time than the first spatiotemporal status.

15. The system of claim 14, wherein the generated historical driver data further includes a reward, the reward being indicative of a total return over the duration of the transition of the driver from the first spatiotemporal status to the second spatiotemporal status.

16. The system of claim 11, wherein the estimating a value function associated with a plurality of order dispatching policies further comprises iteratively incorporating training data and updating in each iteration the estimation of the value function.

17. The system of claim 16, wherein updating in each iteration the estimation of the value function applies a cerebellar model arithmetic controller.

18. The system of claim 17, wherein the output from the cerebellar model arithmetic controller is a sparse multi-dimensional vector.

19. The system of claim 16, wherein updating in each iteration the estimation of the value function applies a hierarchical polygon grid system.

20. The system of claim 19, wherein the hierarchical polygon grid system is a hexagon grid system.
